(19) United States
(12) Patent Application Publication
(10) Pub. No.: US 2007/0299952 A1
(43) Pub. Date: Dec. 27, 2007

(54) External network management interface proxy addressing of data storage drives

(76) Inventors: Brian Gerard Goodman, Tucson, AZ (US); Leonard George Jesionowski, Tucson, AZ (US)

Correspondence Address: JOHN H. HOLCOMBE;IBM CORPORATION, IP LAW DEPT., 8987 E. TANQUE VERDE RD., #309-374, TUCSON, AZ, 85749, US

(21) Appl. No.: 11/473,984

(22) Filed: Jun. 23, 2006

(51) Int. Cl. G06F 15/173; G06F 15/16

(52) U.S. Cl. 709/223; 709/230

(57) ABSTRACT

Management communication for data storage drives, for example, of an automated data storage library. An external network management interface is configured to communicate externally of the library employing at least one proxy address for the data storage drives and employing TCP/IP packaging of network management information. At least one processor is configured to handle TCP/IP commands on behalf of the data storage drives, to determine internal interface addresses of the data storage drives versus the at least one proxy address, and to pass network management information without alteration. At least one internal interface is configured to communicate with the data storage drives employing the internal interface addresses and employing library-drive packaging of the network management information.

### FIELD OF THE INVENTION

This invention relates to data storage systems, and, more particularly, to management communication with respect to data storage drives.

### BACKGROUND OF THE INVENTION

Data storage systems, such as automated data storage libraries, may be managed via an external network management interface, such as Ethernet. The network management interface may support web browsers through HTTP protocols, management interfaces such as SNMP or SMI-S, transfer interfaces such as FTP, etc., as are known to those of skill in the art. Examples of management may comprise gathering information regarding operation of the library, configuring the library, updating library software, etc. In some cases, the library may provide support for attached data storage drives by gathering information from the drive and presenting it in some other form. For example, the library may receive error information from a drive and then send SNMP traps for the error. In another example, the library low level communication structures for obtaining and changing drive settings may be used by the library to provide a web user interface to allow access to these drive settings.

This approach requires coordination between the library developers and the drive developers to provide all of the necessary information and capabilities at both the drives and the library. Further, duplicated work is required to provide the information in one format (as provided by the drive) and then presenting it in another format (as provided on a library web user interface).

### SUMMARY OF THE INVENTION

Control for an automated data storage library, libraries, data storage systems having data storage drives, computer program products and methods provide capability for network management of the data storage drives.

In one embodiment, the control comprises at least one external network management interface configured to communicate externally of the library employing at least one proxy address for the data storage drives and employing TCP/IP packaging of network management information; at least one processor configured to handle TCP/IP commands on behalf of a data storage drive, to determine internal interface addresses of the data storage drives versus the at least one proxy address and to pass network management information without alteration except packaging; and at least one internal interface configured to communicate with the data storage drives employing the internal interface addresses and employing library-drive packaging of the network management information.

Thus, it is the drive developers that may provide the necessary information and capabilities.

In a further embodiment, the proxy address comprises an IP address of the library and the internal interface addresses comprise a unique port number of the IP address for each of the data storage drives.

In another embodiment, the proxy addresses comprise at least one IP address representing the data storage drives.

In a still further embodiment, the processor is configured to convert the packaging between the TCP/IP packaging and the library-drive packaging by assembling and disassembling the network management information between packets of different characteristics and headers.

In still another embodiment, the processor is configured to, as the result of receiving an encryption key request from a data storage drive at the internal interface, send the encryption key request to a key server via the network management interface employing the proxy address for the drive; and configured to pass encryption key(s) received at the external network management interface, as network management information to data storage drive(s) employing the internal interface address and library—drive packaging.

For a fuller understanding of the present invention, reference should be made to the following detailed description taken in conjunction with the accompanying drawings.

### BRIEF DESCRIPTION OF THE DRAWINGS

FIG. 1 is an isometric illustration of an automated data storage library which may implement the present invention;

FIG. 2 is an illustration of an opened frame of the automated data storage library of FIG. 1;

FIG. 3 is a block diagram of an embodiment of the automated data storage library of FIGS. 1 and 2; and

FIG. 4 is a flow chart depicting embodiments of methods in accordance with the present invention.

### DETAILED DESCRIPTION OF THE INVENTION

This invention is described in preferred embodiments in the following description with reference to the Figures, in which like numbers represent the same or similar elements. While this invention is described in terms of the best mode for achieving this invention's objectives, it will be appreciated by those skilled in the art that variations may be accomplished in view of these teachings without deviating from the spirit or scope of the invention.

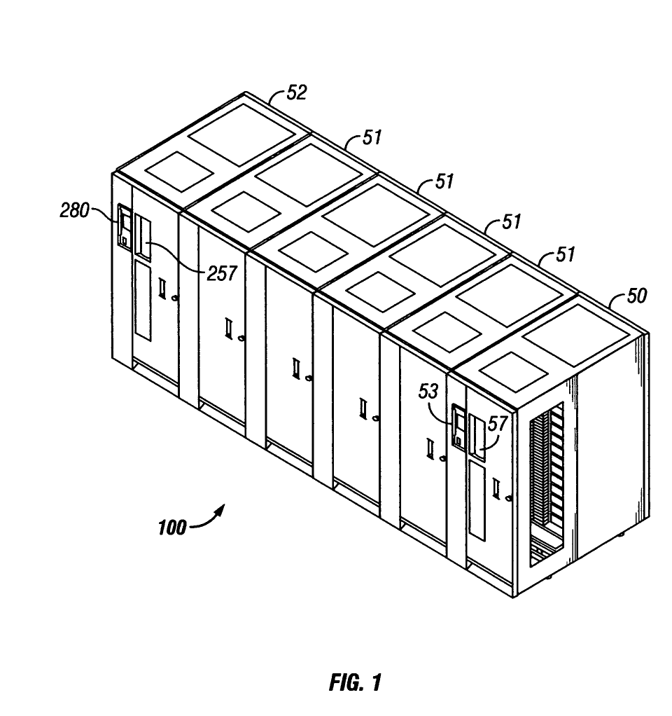

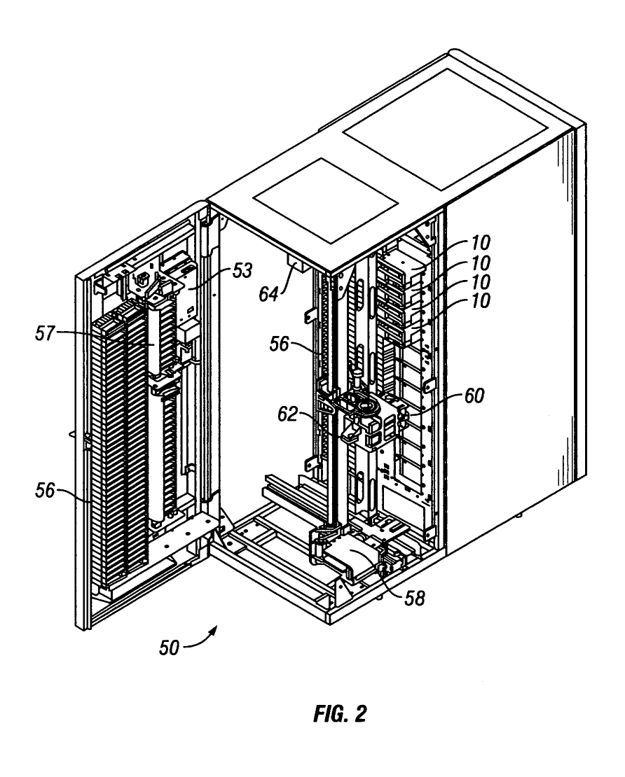

FIGS. 1, 2 and 3 illustrate an embodiment of a data storage system, such as an automated data storage library 100, configured in accordance with the present invention, which is arranged to access data storage media, such as magnetic tape cartridges, and transport the data storage media between storage shelves 56 and data storage drives 10, which data storage drives are configured to read and/or write information with respect to the data storage media. As one example, the data storage drives 10 may comprise magnetic tape data storage drives for reading and/or writing information with respect to magnetic tape data storage cartridges. In the example, the data storage library 100 comprises one or more frames 50, 51, 52, each of which may have a plurality of storage shelves 56 for storing the cartridges. The library 100 may also comprise at least one robot accessor 58, 258 for transporting the cartridges between the storage shelves 56 and the data storage drives 10. The robot accessor 58, 258 comprises a gripper assembly 60 for gripping one or more cartridges, and may comprise an accessor sensor 62, such as an LED (Light Emitting Diode) emitter/detector, a bar code scanner, a camera, or other reading system to read the identifiers or labels of the cartridges or to read other information about the library.

The library 100 also comprises one or more library controllers or processors 64 to operate the library, communicate with an external network 140, communicate with the data storage drives 10, and to communicate with other processors of the library (if present). Additionally, the data storage drives 10 may communicate with a host system or systems 141, 142, directly or indirectly for the transfer of commands and/or data to and from the host system(s). In addition or alternatively, the library controller 64 may communicate with one or more host systems, such as host systems 141, 142, either directly (not shown) or indirectly through one or more data storage drives 10 for the transfer of commands and/or data to and from the host system(s). Further, the library may provide one or more operator panels 53, 260, 280 for communicating with the library controller. The library controller may be set up as a centralized control system, or as a distributed control system. In the example of a distributed control system, additional processors 54, 59, 155, 250, 252, 259 may together with processor 64 comprise the library controller, and operate specific functions of the library. For example, processors 54 and 252, called “WP”, may operate the robot accessors 58, 258 to transport the data storage cartridges, processors 59, 259, called “OP”, may control the operator panels 53, 260, 280, and processors 64, 155, and 250, called “CP”, may provide communications to data storage drives, host systems, etc. An example of an automated data storage library comprises the IBM® 3584 tape library.

The library controller(s) typically comprises logic and/or one or more processors with memory 65 illustrated as provided for processor 64, for storing information and program information for operating the processor(s). Herein, “library controller” or “controller” may comprise one or more computers, workstations, or processors. Herein “processor” may comprise discrete logic, ASIC (Application Specific Integrated Circuits), FPGA (Field Programmable Gate Arrays), microprocessors, any suitable logic, or combinations thereof. The processor typically utilizes memory for responding to program instructions, and the memory may comprise fixed or rewritable memory, and be non-volatile, volatile or both, or data storage devices. The program information may be supplied to the library controller or memory from an external network 140, a wireless link or network, a service port, a host system interface, or by an input from a floppy or optical disk, or by being read from a cartridge, or by a web user interface or other network connection, or by any other suitable means. Processors 54, 59, 155, 250, 252, 259 may also be provided with memory of a lesser, similar or greater capacity, and the memory may also comprise fixed or rewritable memory or data storage devices.

Data storage cartridges may be added to or removed from the library, for example, at input/output stations 57, 257. A magnetic tape data storage cartridge comprises a length of magnetic tape wound on one or two reels. One example of a magnetic tape data storage drive 10 is the IBM® 3580 Ultrium magnetic tape drive. A further example of a magnetic tape data storage drive is the IBM® 3592 TotalStorage Enterprise magnetic tape drive.

The library controller 64 is provided with an external network management interface 66 configured to communicate with the external network 140 using the TCP/IP protocol (or packaging) over Ethernet, as an example. Other hardware and/or software protocols may be used. The interface 66 may also comprise an interface for communication with host systems to receive commands to operate the library and/or data storage drives, and to transfer information to and from the host systems with respect to the library and the data storage drives.

The library controller 64 is additionally provided with at least one internal interface 67 configured to communicate with data storage drives 10. Another internal interface 68 may be provided to communicate with additional processors 54, 59, 155, 250, 252, 259 of a distributed control system and/or one or more redundant library controllers (not shown). The processors 155 and 250 comprise an internal interface similar to interface 67 to communicate with data storage drives 10. The internal interfaces 67, 68 may comprise serial interfaces such as RS-232 (Recommended Standard), CAN (Controller Area Network), USB (Universal Serial Bus), SAS (Serial Attached SCSI), IEEE 1394 (Institute of Electrical and Electronics Engineers), or any other serial data storage drive interface as is known to those of skill in the art. In addition, the internal interfaces may comprise wireless interfaces, such as IEEE 802.11. Alternatively, interfaces 67, 68 may comprise parallel interfaces such as SCSI (Small Computer Systems Interface), or any other parallel interface as is known to those of skill in the art. Still further, interfaces 67, 68 may comprise optical interfaces such as Fibre Channel, ESCON (Enterprise Systems CONnection), or any other optical interface as is known to those of skill in the art. Further, internal interfaces 67, 68 may comprise different hardware protocols with respect to each other.

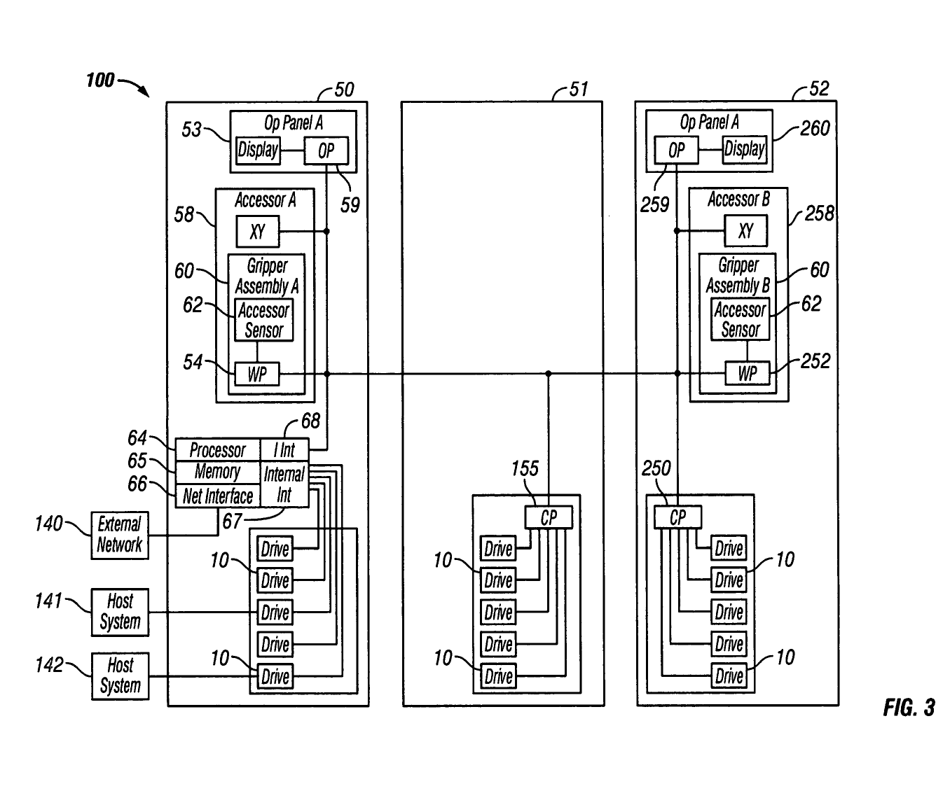

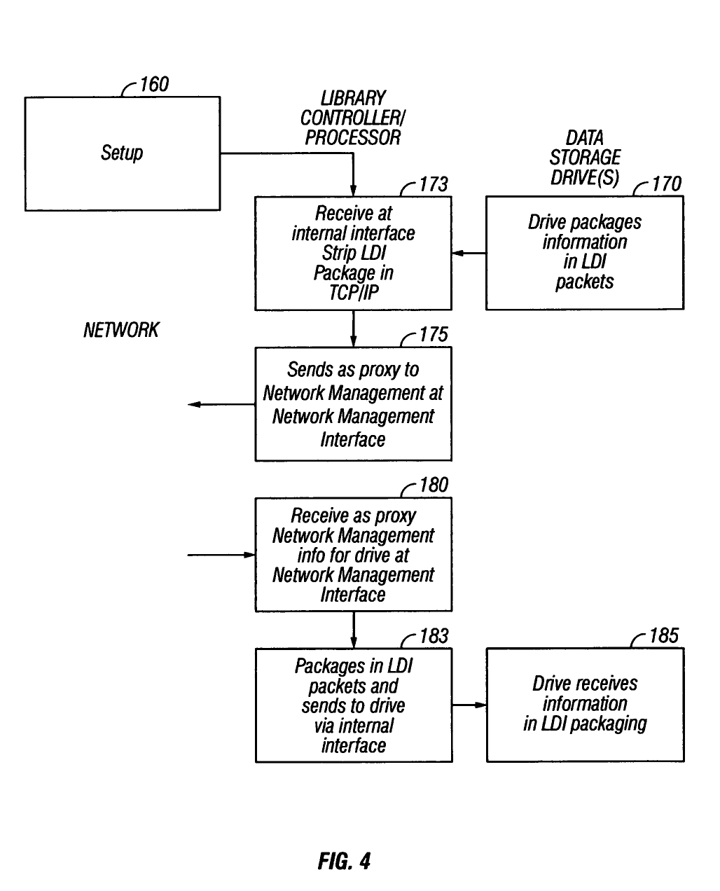

Referring to FIGS. 3 and 4, in one embodiment, at least one processor 64 is configured to provide communication of network management information with respect to data storage drives 10 of a data storage system, such as an automated data storage library 100.

In step 160, at library setup, startup, or configuration, one or more IP (internet protocol) addresses of the library may be set at a library operator panel 53, 260, 280, or at a web user interface, or at some other user interface of the library. Alternatively, the library IP addresses may be automatically determined and/or set. For example, the library IP addresses may be set with DHCP (Dynamic Host Configuration Protocol). The library controller 64 may store the library IP address in memory 65. Internal addressing of the data storage drives may be set in step 160. As with the library IP address, the internal drive addresses may be set manually at a library operator panel 53, 260, 280, or at a web user interface, or at some other user interface of the library. Alternatively, the internal drive addresses may be automatically determined and set. For example, the internal drive addresses may be set with DHCP (Dynamic Host Configuration Protocol). Still further, the internal drive addresses may be determined by the wiring or circuits of the library and/or drives. For example, the library may communicate with each drive by using a single switched UART (Universal Asynchronous Receiver Transmitter). The switch number may comprise the internal drive address. In another example, the library may communicate with each drive by using dedicated UARTs, where the particular UART comprises the internal drive address. In yet another example, the drives may reside on an internal network and the network address of the drive may comprise the internal drive address. The library controller 64 may store the internal drive addressing information in memory 65. Proxy addresses for the data storage drives may be set in step 160. The proxy address provides a means for computer or device on the network to communicate with a particular data storage drive in the library. In one embodiment, the proxy address comprises a unique IP address for each drive in the library. For example, the library maps each internal drive address to a unique IP address. The library controller 64 intercepts or handles any network traffic that is directed to the unique IP addresses associated with the data storage drives, and redirects the network traffic to the correct drive. Any network traffic directed to the IP address of the library would be handled directly by the library controller 64. In another embodiment, the proxy address comprises the library IP address. For example, the library maps each internal drive address to a unique port that is associated with the library IP address. The library controller 64 intercepts or handles any network traffic that is directed to the library IP address and redirects the network traffic to the correct drive, based on the port number specified in the IP addressing. Any network traffic directed to the IP address of the library with either no port information, or with port information indicative of the library, would be handled directly by the library controller 64. Also at startup time, the library controller may be supplied with or develop the cross referencing between the proxy addresses and the internal addresses. “Addresses” may comprise bus addresses and/or path information for multi-drop busses, etc., or may comprise a port or path for point-to-point communication. An example of an “address” in an RS-232 bus is a particular UART (Universal Asynchronous Receiver Transmitter) channel. The cross referencing of addresses may comprise network address translation, port address translation, path development or linkage, and may comprise firewall linkages. The proxy address may comprise an IP address of the library and the internal interface addresses may comprise a unique port number of the IP address for each of the data storage drives. Alternatively, the proxy addresses may comprise at least one IP address representing the data storage drives.

In step 170, a data storage drive 10 provides network management information in library-drive packaging and sends the information to the library controller 64. The library-drive packaging is the communication protocol of the internal interface 67, and herein is called “LDI packets”. The arrangement of the packets is consistent with the internal interface communication protocol, and may comprise packet size information, a header and a trailer, a checksum, etc.

In step 173, the library controller 64 determines the proxy address of the data storage drive sending the information.

The library controller converts the packaging between the library-drive packaging and the TCP/IP packaging by assembling and disassembling the network management information between packets of different characteristics and headers. The network management information is passed without alteration. In one example, the library controller strips the LDI packets from the information, adds TCP/IP source and destination routing information using the proxy address of the drive, packaging the information as TCP/IP packets, and, in step 175 sends the TCP/IP packets at the network management interface 66 to the network management device(s) on the external network 140 as the proxy for the data storage drive, handling TCP/IP commands on behalf of the data storage drive.

Alternatively, the library may provide the drive with its proxy address, at step 160 for example, and the drive may provide the source and/or destination routing information prior to sending the LDI packets in step 170.

In step 180, a network management device sends TCP/IP information to the data storage drive using the proxy address of the drive, which information is received by the library controller 64 at the network management interface 66.

In step 183, the library controller 64 handles TCP/IP commands on behalf of the data storage drive and determines the internal address of the data storage drive referenced by the proxy address.

The library controller converts the packaging between the TCP/IP packaging and the library-drive packaging by assembling and disassembling the network management information between packets of different characteristics and headers. The network management information is passed without alteration. For example, the library controller wraps the TCP/IP information in LDI packets, packaging the information as LDI packets, addresses the information to the data storage drive using the internal addressing, and in step 185, transfers the LDI packets at the internal interface 67 to the data storage drive 10.

The management information may be communicated internally directly with the internal interface 67, or indirectly via internal interface 68 and a processor 155 or 250, or the external TCP/IP information may be relayed to processor 155 or 250, and the processor may provide the functions of processor 64 discussed above.

Thus, the library controller 64, 155 and 250 communicate externally of the library employing at least one proxy address for the data storage drive, handling TCP/IP commands on behalf of the data storage drive, and employing TCP/IP packaging of network management information; determine internal interface addresses of the data storage drives versus the proxy address(es); pass network management information without alteration; and communicate internally of the library with the data storage drives employing the internal interface addresses and employing library-drive packaging of the network management information.

In one embodiment, a drive obtains one or more encryption keys from a key server, using the library as a TCP/IP proxy to the key server. This embodiment will be described with reference to FIGS. 3 and 4. In step 160, one or more IP addresses, or other network routing information such as a host name, of one or more key servers is entered at a user interface of the library. In addition, library and/or drive IP address(es) may be set in step 160, as discussed above. At some point in time, the drive 10 determines that one or more encryption keys are required to write data to and/or read data from the media of the data storage drive. In step 170, the drive 10 requests the encryption key(s) by sending the appropriate key server request to the library in the form of LDI packets at internal interface 67. In step 173, the library controller 64 receives the LDI packets of the request, strips the LDI packaging, and adds source and/or destination routing information (if the drive has not already done so, as discussed above). In step 175, the library controller 64 sends the key request at network management interface 66 to at least one key server of external network 140 specified in step 160 employing the proxy address and packaging. At some point in time, a key server sends one or more encryption keys destined for one or more drives 10. In step 180, one or more keys are received from a key server at network management interface 66. In step 183, the library packages the key(s) in LDI packets and sends the key(s) to the appropriate drive(s) 10 without alteration using the internal interface 67, thereby passing the keys to drives as network management information. In step 185, the drive(s) 10 receives the LDI packets and uses the key(s) to encrypt and/or decrypt data stored on the media of the data storage drive 10.

Those of skill in the art will understand that the steps of FIG. 4 are unordered and refer to bi-directional communication. Further, the actions of the individual steps may occur at different times or under different conditions. Still further, those of skill in the art will understand that differing specific component arrangements may be employed than those illustrated herein.

While the invention has been illustrated with reference to a tape library, it should be apparent that this invention may be applied to any storage subsystem that comprises data storage drives of removable or non-removable media types. Examples of removable and non-removable media drives may include, but without limitation, magnetic or optical tape drives, magnetic or optical disk drives, electronic media drives, floppy drives, hard disk drives, etc.

While the preferred embodiments of the present invention have been illustrated in detail, it should be apparent that modifications and adaptations to those embodiments may occur to one skilled in the art without departing from the scope of the present invention as set forth in the following claims.

What is claimed is:

1. A control for an automated data storage library, said library having at least one data storage drive configured to read and/or write information with respect to data storage media, the control comprising:
at least one external network management interface configured to communicate externally of said library employing at least one proxy address for said data storage drives and employing TCP/IP packaging of network management information;
at least one processor configured to handle TCP/IP commands on behalf of said data storage drives, to determine internal interface addresses of said data storage drives versus said at least one proxy address, and to pass network management information without alteration; and
at least one internal interface configured to communicate with said data storage drives employing said internal interface addresses and employing library-drive packaging of said network management information.

2. The control of claim 1, wherein said proxy address comprises an IP address of said library and said internal interface addresses comprise a unique port number of said IP address for each of said data storage drives.

3. The control of claim 1, wherein said proxy addresses comprise at least one IP address representing said data storage drives.

4. The control of claim 1, wherein said at least one processor is configured to convert said packaging between said TCP/IP packaging and said library-drive packaging by assembling and disassembling said network management information between packets of different characteristics and headers.

5. The control of claim 1, wherein said at least one processor additionally is configured to, as the result of receiving an encryption key request from a data storage drive at said at least one internal interface, send said encryption key request to a key server via said at least one network management interface employing said proxy address for said data storage drive; and configured to pass at least one encryption key received at said at least one external network management interface, as said network management information to at least one of said data storage drives employing said internal interface address and library-drive packaging.

6. An automated data storage library comprising:
a plurality of storage shelves configured to store data storage media;
at least one data storage drive configured to read and/or write information with respect to said data storage media;
a robot configured to transport data storage media between said storage shelves and said data storage drives;
at least one external network management interface configured to communicate externally of said library employing at least one proxy address for said data storage drives and employing TCP/IP packaging of network management information:
at least one processor configured to handle TCP/IP commands on behalf of said data storage drives, to determine internal interface addresses of said data storage drives versus said at least one proxy address, and to pass network management information without alteration; and
at least one internal interface configured to communicate with said data storage drives employing said internal interface addresses and employing library-drive packaging of said network management information.

7. The automated data storage library of claim 6, wherein said proxy address comprises an IP address of said library and said internal interface addresses comprise a unique port number of said IP address for each of said data storage drives.

8. The automated data storage library of claim 6, wherein said proxy addresses comprise at least one IP address representing said data storage drives.

9. The automated data storage library of claim 6, wherein said at least one processor is configured to convert said packaging between said TCP/IP packaging and said library-drive packaging by assembling and disassembling said network management information between packets of different characteristics and headers.

10. The automated data storage library of claim 6, wherein said at least one processor additionally is configured to, as the result of receiving an encryption key request from a data storage drive at said at least one internal interface, send said encryption key request to a key server via said at least one network management interface employing said proxy address for said data storage drive; and configured to pass at least one encryption key received at said at least one external network management interface, as said network management information to at least one of said data storage drives employing said internal interface address and library-drive packaging.

11. A method for communicating network management information for at least one data storage drive of an automated data storage library, said data storage drive configured to read and/or write information with respect to data storage media, comprising the steps of:
communicating externally of said library employing at least one proxy address for said data storage drives, handling TCP/IP commands on behalf of said data storage drives, and employing TCP/IP packaging of network management information;
determining internal interface addresses of said data storage drives versus said at least one proxy address, and passing network management information without alteration; and
communicating internally of said library with said data storage drives employing said internal interface addresses and employing library-drive packaging of said network management information.

12. The method of claim 11, wherein said proxy address comprises an IP address of said library and said internal interface addresses comprise a unique port number of said IP address for each of said data storage drives.

13. The method of claim 11, wherein said proxy addresses comprise at least one IP address representing said data storage drives.

14. The method of claim 11, additionally comprising the step of convert said packaging between said TCP/IP packaging and said library-drive packaging by assembling and disassembling said network management information between packets of different characteristics and headers.

15. The method of claim 11, additionally comprising the steps of:
as the result of communicating internally of said library and receiving an encryption key request from a data storage drive, communicating externally of said library sending said encryption key request to a key server employing said proxy address for said data storage drive; and
passing at least one encryption key received via said communicating externally step, as said network management information to at least one of said data storage drives employing said internal interface address and library-drive packaging.

16. A computer program product tangibly embodied in a computer readable medium usable with a programmable computer, said computer program product having computer readable code embodied therein, for communicating network management information for at least one data storage drive of an automated data storage library, said data storage drive configured to read and/or write information with respect to data storage media, said computer program product comprising instructions for:
communicating externally of said library employing at least one proxy address for said data storage drives, handling TCP/IP commands on behalf of said data storage drives, and employing TCP/IP packaging of network management information;
determining internal interface addresses of said data storage drives versus said at least one proxy address and passing network management information without alteration; and
communicating internally of said library with said data storage drives employing said internal interface addresses and employing library-drive packaging of said network management information.

17. The computer program product of claim 16, wherein said proxy address comprises an IP address of said library and said internal interface addresses comprise a unique port number of said IP address for each of said data storage drives.

18. The computer program product of claim 16, wherein said proxy addresses comprise at least one IP address representing said data storage drives.

19. The computer program product of claim 16, additionally comprising computer instructions for converting said packaging between said TCP/IP packaging and said library-drive packaging by assembling and disassembling said network management information between packets of different characteristics and headers.

20. The computer program product of claim 16, additionally comprising computer instructions for:
as the result of communicating internally of said library and receiving an encryption key request from a data storage drive, communicating externally of said library sending said encryption key request to a key server employing said proxy address for said data storage drive; and
passing at least one encryption key received via said communicating externally step, as said network management information to at least one of said data storage drives employing said internal interface address and library-drive packaging.

21. A data storage system comprising:
at least one data storage drive configured to read and/or write information with respect to data storage media;
at least one external network management interface configured to communicate externally of said data storage system employing at least one proxy address for said data storage drives and employing TCP/IP packaging of network management information;
at least one processor configured to handle TCP/IP commands on behalf of said data storage drives, to determine internal interface addresses of said data storage drives versus said at least one proxy address, and to pass network management information without alteration; and
at least one internal interface configured to communicate with said data storage drives employing said internal interface addresses and employing processor-drive packaging of said network management information.

22. The data storage system of claim 21, wherein said proxy address comprises an IP address of said at least one processor and said internal interface addresses comprise a unique port number of said IP address for each of said data storage drives.

23. The data storage system of claim 21, wherein said proxy addresses comprise at least one IP address representing said data storage drives.

24. The data storage system of claim 21, wherein said at least one processor is configured to convert said packaging between said TCP/IP packaging and said processor-drive packaging by assembling and disassembling said network management information between packets of different characteristics and headers.

25. The data storage system of claim 21, wherein said at least one processor additionally is configured to, as the result of receiving an encryption key request from a data storage drive at said at least one internal interface, send said encryption key request to a key server via said at least one network management interface employing said proxy address for said data storage drive; and configured to pass at least one encryption key received at said at least one external network management interface, as said network management information to at least one of said data storage drives employing said internal interface address and library-drive packaging.
